(19) United States
(12) Patent Application Publication
(10) Pub. No.: US 2009/0108760 A1
(43) Pub. Date: Apr. 30, 2009

(54) TROUBLE DETECTING CIRCUIT

(76) Inventor: Hiroyuki MIYAZAKI, Tokyo (JP)

Correspondence Address: PATENT DOCKET CLERK;COWAN, LIEBOWITZ & LATMAN, P.C., 1133 AVENUE OF THE AMERICAS, NEW YORK, NY, 10036, US

(21) Appl. No.: 12/254,242

(22) Filed: Oct. 20, 2008

(30) Foreign Application Priority Data
Oct. 24, 2007 (JP) 2007-276945

(51) Int. Cl. H05B 37/03

(52) U.S. Cl. 315/130

(57) ABSTRACT

A trouble detecting circuit includes (a) a loop circuit conducting a loop current to two discharge tube lamps in a normal state, in which the two discharge tube lamps are driven with two alternating driving voltages having phases reverse to each other by one or two secondary side windings of one or two transformers, and (b) a monitoring circuit monitoring a voltage between two points which are at a substantially same potential in a normal state in the loop circuit.

### REFERENCE TO RELATED APPLICATION

This application relates to and claims priority to Japanese Patent Application No. 2007-276945, filed Oct. 24, 2007, the entire disclosure of which is incorporated herein by reference.

### BACKGROUND OF THE INVENTION

1. Field of the Invention

The present invention relates to a trouble detecting circuit which detects a trouble of a discharge tube lamp.

2. Description of the Related Art

A discharge tube lamp is lighted with a high driving voltage of a high frequency applied by a drive circuit. Normally, the state of such a discharge tube lamp is monitored by means of measuring a conduction current through the discharge tube lamp. This conduction current is measured as a direct current voltage by rectifying a voltage between ends of a current measuring resistor with a diode and smoothing the voltage with a smoothing circuit. For monitoring the states of a plurality of discharge tube lamps, a plurality of direct current voltages are obtained corresponding to conduction currents through the discharge tube lamps and are combined, and the states of the discharge tube lamps are monitored based on the voltage value after being combined (for example, refer to Japanese Patent Application Laid-open No. 2005-267923).

### SUMMARY OF THE INVENTION

However, in the aforementioned circuit, one measuring circuit is necessary for one conduction current through one discharge tube lamp, and when there are many discharge tube lamps, the circuit scale becomes large in proportion to the number of lamps.

Further, in the aforementioned circuit, the states of a plurality of discharge tube lamps are monitored based on the voltage obtained by combining a plurality of measured voltages. Thus, in case that a large number of discharge tube lamps is driven, it is necessary to finely adjust each rectifying/smoothing circuit provided for each of the discharge tube lamps, so as to allow detection of a trouble through distinguishing a combined voltage in a normal state and a combined voltage when one of the large number of discharge tube lamps is abnormal.

The present invention is made in view of the above problem, and an object thereof is to obtain a trouble detecting circuit with which the circuit scale need not be large when a large number of discharge tube lamps is driven.

To solve the above-described problems, the present invention provides as follows.

A trouble detecting circuit according to the present invention includes (a) a loop circuit conducting a loop current to two discharge tube lamps in a normal state, in which the two discharge tube lamps are driven with two alternating driving voltages having phases reverse to each other by one or two secondary side windings of one or two transformers, and (b) a monitoring circuit monitoring a voltage between two points which are at a substantially same potential in a normal state in the loop circuit.

Accordingly, by detecting a voltage variation at the above two points due to fluctuation of the loop current in an abnormal state of the discharge tube lamps, a trouble of the discharge tube lamps can be detected. At this time, a voltage with a significant amplitude is detected only in an abnormal state, and thus a normal state and an abnormal state can be distinguished easily. Since one monitoring circuit is enough for two discharge tube lamps, the circuit scale of the trouble detecting circuit need not be large when a large number of discharge tube lamps is driven.

Further, a trouble detecting circuit according to the present invention may be provided as follows in addition to the above-described trouble detecting circuit. Specifically, one of the two points is a ground point.

Accordingly, the monitoring circuit just needs to monitor a potential from the ground point for another one point, and therefore the circuit structure can be simple.

Further, a trouble detecting circuit according to the present invention may be provided as follows in addition to the above-described trouble detecting circuits. Specifically, the other one of the two points is grounded via a detection resistor.

Further, a trouble detecting circuit according to the present invention may be provided as follows in addition to the above-described trouble detecting circuits. Specifically, the monitoring circuit is connected to a lower voltage side of the two discharge tube lamps.

Further, a trouble detecting circuit according to the present invention may be provided as follows in addition to the above-described trouble detecting circuits. Specifically, the monitoring circuit is connected to a lower voltage side of the secondary side windings of the two transformers.

A trouble detecting circuit according to the present invention includes (a) a plurality of loop circuits of which each conducts a loop current to the two discharge tube lamps in a normal state, in which the two discharge tube lamps are driven with two alternating driving voltages having phases reverse to each other by one or two secondary side windings of one or two transformers, and (b) a monitoring circuit monitoring a voltage between a first connection point and a second connection point, where the first connection point is connected to a plurality of first points, the second connection point is connected to a plurality of second points, and a respective one of the first points and a respective one of the second points are at substantial same potential in a respective one of the loop circuits in a normal state.

Accordingly, by detecting a voltage variation between the first and the second connection points due to fluctuation of the loop current in an abnormal state of the discharge tube lamps, a trouble of the discharge tube lamps can be detected. At this time, a voltage with a significant amplitude is detected only in an abnormal state, and thus a normal state and an abnormal state can be distinguished easily. Since one monitoring circuit is enough for a plurality of discharge tube lamps, the circuit scale of the trouble detecting circuit need not be large when a large number of discharge tube lamps is driven.

According to the present invention, it is possible to obtain a trouble detection circuit in which the circuit scale need not be large even when a large number of discharge tube lamps is driven.

The above and other objects, characteristic features and advantages of the present invention will be more evident from the attached drawings and the following detailed description.

### BRIEF DESCRIPTION OF THE DRAWINGS

The following detailed description, given by way of example and not intended to limit the present invention solely thereto, will best be appreciated in conjunction with the accompanying drawings, wherein like reference numerals denote like elements and parts, in which:

FIG. 1 is a circuit diagram showing a structure of a trouble detecting circuit according to Embodiment 1 of the present invention;

FIG. 2 is a diagram showing a potential v0 at an equilibrium point in a loop circuit of FIG. 1;

FIG. 3 is a diagram explaining an example of a trouble detection operation in the circuit of FIG. 1;

FIG. 4 is a circuit diagram showing a structure of a trouble detecting circuit according to Embodiment 2 of the present invention;

FIG. 5 is a diagram explaining an example of a trouble detection operation in the circuit of FIG. 4;

FIG. 6A and FIG. 6B are circuit diagrams showing a structure of a trouble detecting circuit according to Embodiment 3 of the present invention;

FIG. 7 is a diagram explaining an example of a trouble detection operation of the circuit in FIG. 6B;

FIG. 8 is a circuit diagram showing a structure of a trouble detecting circuit according to Embodiment 4 of the present invention;

FIG. 9A and FIG. 9B are circuit diagrams showing a structure of a trouble detecting circuit according to Embodiment 5 of the present invention;

FIG. 10 is a diagram explaining an example of a trouble detection operation of the circuit in FIG. 9B;

FIG. 11 is a circuit diagram showing a structure of a trouble detecting circuit according to Embodiment 6 of the present invention;

FIG. 12 is a circuit diagram showing a structure of a trouble detecting circuit according to Embodiment 7 of the present invention;

FIG. 13 is a circuit diagram showing a structure of a trouble detecting circuit according to Embodiment 8 of the present invention;

FIG. 14 is a circuit diagram showing a structure of a trouble detecting circuit according to Embodiment 9 of the present invention; and

FIG. 15 is a circuit diagram showing a structure of a trouble detecting circuit according to Embodiment 10 of the present invention.

### DETAILED DESCRIPTION OF THE PREFERRED EMBODIMENTS

Hereinafter, embodiments of the present invention will be explained based on the drawings.

### Embodiment 1

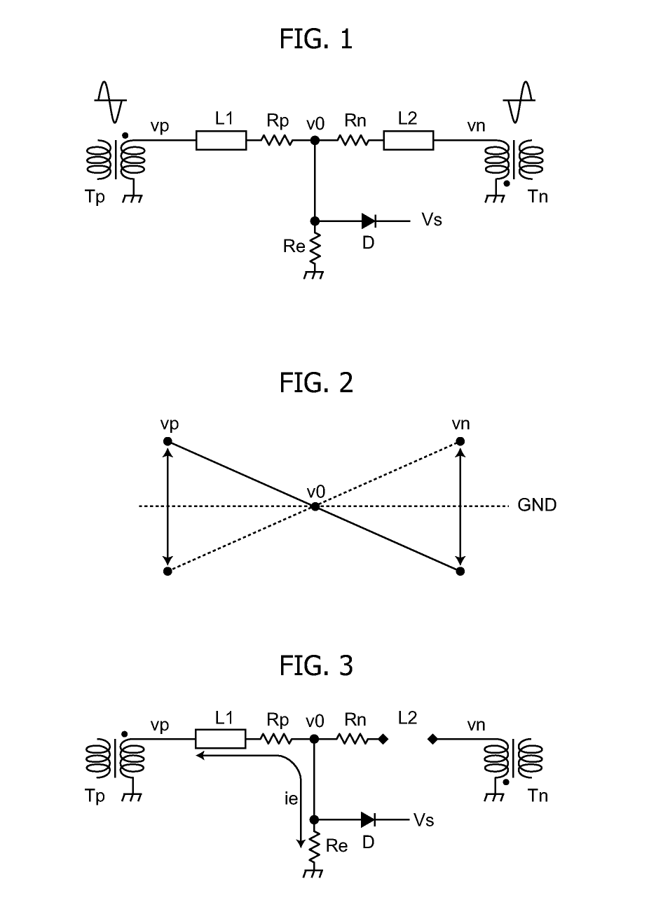

FIG. 1 is a circuit diagram showing a structure of a trouble detecting circuit according to Embodiment 1 of the present invention. In FIG. 1, high-frequency transformers Tp, Tn are transformers to apply driving voltages to cold-cathode tube lamps L1, L2. The driving voltage applied to the cold-cathode tube lamp L1 by the high-frequency transformer Tp and the driving voltage applied to the cold-cathode tube lamp L2 by the high-frequency transformer Tn are high-frequency alternating voltages having substantially same amplitudes and having phases reverse to each other. Note that the state of “having phases reverse to each other” means a state that one of the phases is shifted from the other by substantially 180 degrees. Further, load resistors Rp, Rn are resistors for stabilizing conduction currents through the cold-cathode tube lamps L1, L2. Resistance values of the load resistor Rp and the load resistor Rn are substantially the same.

In Embodiment 1, one end of a secondary side winding of the high-frequency transformer Tp is connected to one end of the cold-cathode tube lamp L1, and the other end of the secondary side winding of the high-frequency transformer Tp is connected to the ground point. The other end of the cold-cathode tube lamp L1 is connected to one end of the load resistor Rp. Further, in Embodiment 1, one end of a secondary side winding of the high-frequency transformer Tn is connected to one end of the cold-cathode tube lamp L2, and the other end of the secondary side winding of the high-frequency transformer Tn is connected to the ground point. The other end of the cold-cathode tube lamp L2 is connected to one end of the load resistor Rn. That is, the other end of the secondary side winding of the high-frequency transformer Tp and the other end of the secondary side winding of the high-frequency transformer Tn are in a state of being electrically connected to each other. Then the other end of the load resistor Rp and the other end of the load resistor Rn are connected to each other.

Accordingly, a loop circuit is formed via the cold-cathode tube lamps L1, L2, the secondary side windings of the high-frequency transformers Tp, Tn and the load resistors Rp, Rn, and an alternating loop current flows along this loop circuit in a normal state.

Further, in a different point of view, between the connection point of the load resistor Rp and the load resistor Rn and the ground point, there are connected (a) a first series circuit by the load resistor Rp, the cold-cathode tube lamp L1 and the secondary side winding of the high-frequency transformer Tp and (b) a second series circuit by the load resistor Rn, the cold-cathode tube lamp L2 and the secondary side winding of the high-frequency transformer Tn. The impedance of the first series circuit and the impedance of the second series circuit are substantially the same, and the high-frequency transformer Tp and the high-frequency transformer Tn apply driving voltages by phases reverse to each other. Thus, a potential v0 at the connection point of the load resistor Rp and the load resistor Rn becomes a constant potential that is substantially the same as the potential of the ground point. Hereinafter, a point where a potential becomes constant in a normal state in this manner besides the ground point within a loop circuit is referred to as an equilibrium point. FIG. 2 is a diagram showing the potential v0 at the equilibrium point in the loop circuit of FIG. 1. As shown in FIG. 2, an output voltage vp of the secondary side winding of the high-frequency transformer Tp and an output voltage vn of the secondary side winding of the high frequency transformer Tn have phases reverse to each other, and the secondary side windings of the high-frequency transformers Tp, Tn are connected to the ground point. Thus, the potential v0 at the equilibrium point becomes substantially the same as the potential GND at the ground point and becomes substantially constant.

In addition to the aforementioned circuit, one end of an error detection resistor Re is connected to the connection point of the load resistor Rp and the load resistor Rn, and the other end of the error detection resistor Re is connected to the ground point. Then a voltage between ends of the error detection resistor Re is rectified by a diode D, and the potential v0 at the equilibrium point is detected as a direct-current detection voltage Vs. In Embodiment 1, the error detection resistor Re and the diode D constitute a monitoring circuit for monitoring the potential at the equilibrium point.

In the following part, an operation of the above circuit will be explained.

In a normal state, as described above, a loop current flows in the loop circuit, and the potential v0 at the equilibrium point becomes substantially the same as the potential GND at the ground point, and the detection voltage Vs becomes substantially zero.

In an abnormal state, one of the cold-cathode tube lamps L1, L2 turns to an open state or short-circuited state. Accordingly, the current value of the loop current fluctuates. Further, in such abnormal state, the impedance of the above-described first series circuit and the impedance of the second series circuit are no longer the same, and hence the potential v0 at the equilibrium point deviates from the potential GND at the ground point. Accordingly, the potential v0 at the equilibrium point becomes an alternating current having an amplitude, and the detection voltage Vs becomes a voltage value that is not zero according to the trouble. Therefore, for example, when the detection voltage Vs surpasses a predetermined threshold, it is determined that a trouble has occurred.

FIG. 3 is a diagram explaining an example of a trouble detection operation in the circuit of FIG. 1. As shown in FIG. 3, when the cold-cathode tube lamp L2 fails and turns to an open state, the above-described loop circuit is cut, and hence the potential at the equilibrium point deviates from the potential GND at the ground point. Accordingly, an error current ie flows through the error detection resistor Re between the equilibrium point in a normal state and the ground point. Thus, a voltage is generated at both ends of the error detection resistor Re and this both-end voltage is rectified and detected as the direct-current detection voltage Vs. Therefore, when a trouble is detected, the detection voltage Vs increases. In addition, also when the cold-cathode tube lamp L1 fails and turns to an open state, the detection voltage Vs increases. Further, also when the cold-cathode tube lamp L1 or the cold-cathode tube lamp L2 fails and turns to a short-circuited state, the detection voltage Vs increases. Further, also when the cold-cathode tube lamp L1 or the cold-cathode tube lamp L2 fails without reaching an open state or a short-circuited state but consequently the impedance changes slightly, the detection voltage Vs increases.

As mentioned above, according to Embodiment 1, the loop circuit including the secondary side windings of the high-frequency transformers Tp, Tn and the load resistors Rp, Rn is formed, and the monitoring circuit is formed by the error detection resistor Re and the diode D. In this loop circuit, the secondary side windings of the high-frequency transformers Tp, Tn, which drive the two cold-cathode tube lamps L1, L2 with the two alternating driving voltages having phases reverse to each other, cause a loop current to flow through the two cold-cathode tube lamps L1, L2 in a normal state. Then this monitoring circuit monitors the voltage between the ground point and the equilibrium point in this loop circuit.

Accordingly, a trouble of the cold-cathode tube lamps L1, L2 is detected by detecting a potential variation at the equilibrium point due to fluctuation of the loop current in an abnormal state of the cold-cathode tube lamps L1, L2. At this time, a voltage with a significant amplitude is detected only in an abnormal state, and thus a normal state and an abnormal state can be distinguished easily.

Since one monitoring circuit monitoring a potential at one point is enough for two cold-cathode tube lamps L1, L2, the circuit scale of the trouble detecting circuit need not be large when a large number of cold-cathode tube lamps is driven. Therefore, the number of electronic parts can be reduced, and cost reduction of a product can be realized. Further, since a monitoring circuit is not provided for each one of the cold-cathode tube lamps, it is not required to perform adjustment between monitoring circuits.

Further, according to Embodiment 1 described above, since the first series circuit and the second series circuit have the same structures, the potential v0 at the equilibrium point does not easily fluctuate due to a temperature variation or the like, and hence the trouble detection can be performed favorably even when there is an environmental change. Also at the time of burst light control, the potential v0 of the equilibrium point does not easily fluctuate and hence the trouble detection can be performed favorably.

### Embodiment 2

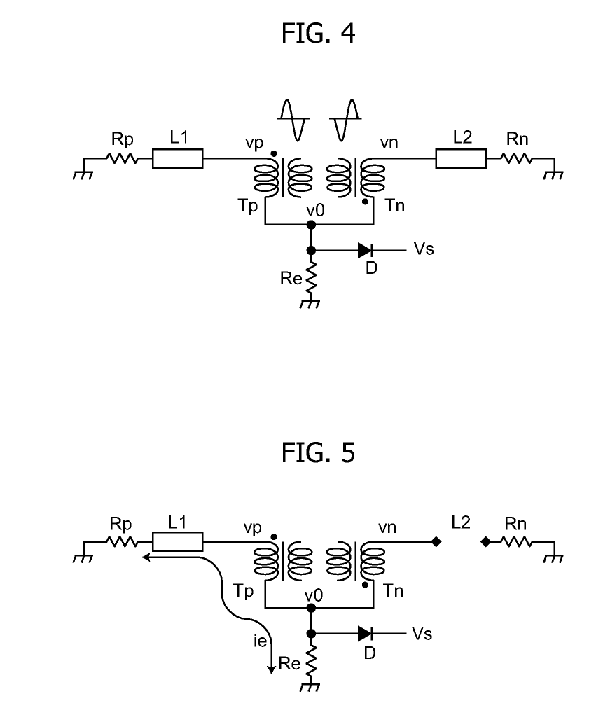

FIG. 4 is a circuit diagram showing a structure of a trouble detecting circuit according to Embodiment 2 of the present invention. In FIG. 4, cold-cathode tube lamps L1, L2, high-frequency transformers Tp, Tn and load resistors Rp, Rn are the same as those in Embodiment 1.

However, in Embodiment 2, the ground point is different from the case of Embodiment 1. In Embodiment 1, the connection point of one end of the secondary side winding of the high-frequency transformer Tp and one end of the secondary side winding of the high-frequency transformer Tn is the ground point, but in Embodiment 2, a connection point of the load resistor Rp and the load resistor Rn is the ground point.

Further, between a connection point of a secondary side winding of the high-frequency transformer Tp and a secondary side winding of the high-frequency transformer Tn and the ground point, there are connected (a) a first series circuit by the load resistor Rp, the cold-cathode tube lamp L1 and the secondary side winding of the high-frequency transformer Tp and (b) a second series circuit by the load resistor Rn, the cold-cathode tube lamp L2 and the secondary side winding of the high-frequency transformer Tn. The impedance of the first series circuit and the impedance of the second series circuit are substantially the same, and the high-frequency transformer Tp and the high-frequency transformer Tn apply driving voltages by phases reverse to each other. Thus, a potential v0 at the connection point of the secondary side winding of the high-frequency transformer Tp and the secondary side winding of the high-frequency transformer Tn becomes a constant potential that is substantially the same as the potential of the ground point

Therefore, in Embodiment 2, the connection point of one end of the secondary side winding of the high-frequency transformer Tp and one end of the secondary side winding of the high-frequency transformer Tn becomes an equilibrium point in a normal state. Accordingly, the monitoring circuit having the error detection resistor Re and the diode D monitors a potential at the connection point of one end of the secondary side winding of the high-frequency transformer Tp and one end of the secondary side winding of the high-frequency transformer Tn.

In the following part, an operation of the above circuit will be explained.

In a normal state, a loop current flows in a loop circuit is formed via the secondary side windings of the high-frequency transformers Tp, Tn, the load resistors Rp, Rn, and the cold-cathode tube lamps L1, L2. The potential v0 at the equilibrium point becomes substantially the same as the potential GND at the ground point, and the detection voltage Vs becomes substantially zero. At this time, if there is no difference in impedance characteristics between the high-frequency transformer Tp and the high-frequency transformer Tn, between the load resistor Rp and the load resistor Rn, and between the cold-cathode tube lamp L1 and the cold-cathode tube lamp L2, the potential v0 at the equilibrium point becomes the same as the potential GND at the ground point. When there is a little difference in impedance characteristics therebetween to the degree of an error, the potential v0 at the equilibrium point does not become exactly the same as the potential GND at the ground point but becomes substantially the same. Even if there is such an error in some degree, there will be no problem in particular for trouble detection.

In an abnormal state, one of the cold-cathode tube lamps L1, L2 turns to an open state or short-circuited state. Accordingly, the current value of the loop current fluctuates. Further, in such abnormal state, the impedance of the above-described first series circuit and the impedance of the second series circuit are no longer the same, and hence the potential v0 at the equilibrium point deviates from the potential GND at the ground point. Accordingly, the potential v0 at the equilibrium point becomes an alternating current having an amplitude, and the detection voltage Vs becomes a voltage value that is not zero according to the trouble. Therefore, for example, when the detection voltage Vs surpasses a predetermined threshold, it is determined that a trouble has occurred.

FIG. 5 is a diagram explaining an example of a trouble detection operation in the circuit of FIG. 4. As shown in FIG. 5, when the cold-cathode tube lamp L2 fails and turns to an open state, an error current ie flows through the error detection resistor Re similarly to the case of Embodiment 1. Therefore, when a trouble is detected, the detection voltage Vs increases.

As mentioned above, according to Embodiment 2, a trouble of the cold-cathode tube lamps L1, L2 is detected by detecting a potential variation at the equilibrium point due to fluctuation of the loop current in an abnormal state of the cold-cathode tube lamps L1, L2. At this time, a voltage with a significant amplitude is detected only in an abnormal state, and thus a normal state and an abnormal state can be distinguished easily.

Since one monitoring circuit is enough for two cold-cathode tube lamps L1, L2, the circuit scale of the trouble detecting circuit need not be large when a large number of cold-cathode tube lamps are driven. Therefore, the number of electronic parts can be reduced, and cost reduction of a product can be realized. Further, since a monitoring circuit is not provided for each one of the cold-cathode tube lamps is not made, it is not required to perform adjustment between monitoring circuits.

### Embodiment 3

A trouble detecting circuit according to Embodiment 3 of the present invention has two loop circuits of which each is the same as the loop circuit in Embodiment 1, and monitors a potential at a connection point connecting equilibrium points of the two loop circuits by one monitoring circuit.

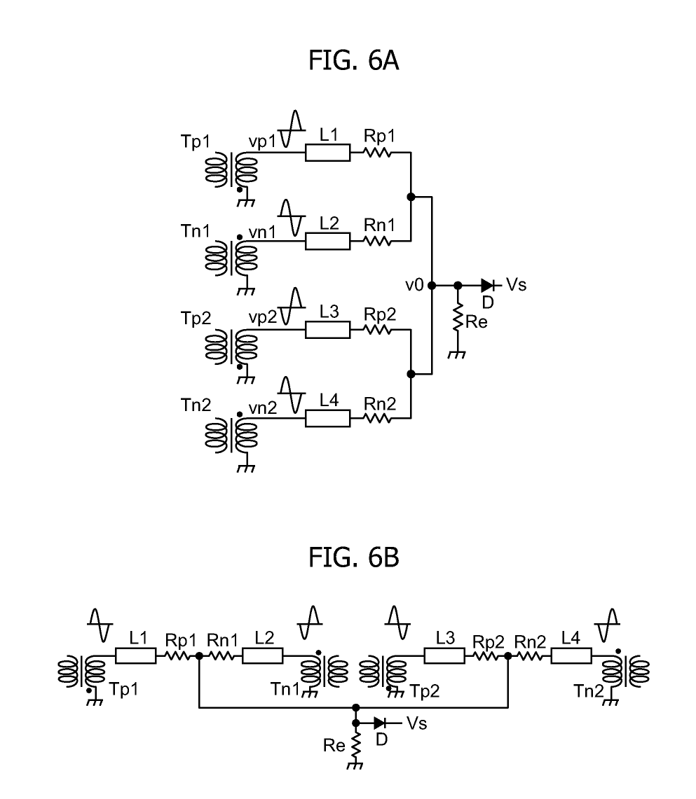

FIG. 6A and FIG. 6B are circuit diagrams showing a structure of the trouble detecting circuit according to Embodiment 3 of the present invention. The circuit in FIG. 6A and the circuit in FIG. 6B are the same.

High-frequency transformers Tp1, Tn1 and load resistors Rp1, Rn1 in Embodiment 3 are the same as the high-frequency transformers Tp, Tn and the load resistors Rp, Rn of Embodiment 1. Therefore, a first loop circuit is formed via cold-cathode tube lamps L1, L2, secondary side windings of the high-frequency transformers Tp1, Tn1 and the load resistors Rp1, Rn1, and in a normal state, an alternating loop current flows along this loop circuit.

Further, high-frequency transformers Tp2, Tn2 and load resistors Rp2, Rn2 in Embodiment 3 are the same as the high-frequency transformers Tp, Tn and the load resistors Rp, Rn of Embodiment 1. Therefore, a second loop circuit is formed via cold-cathode tube lamps L3, L4, secondary side windings of the high-frequency transformers Tp2, Tn2 and the load resistors Rp2, Rn2, and in a normal state, an alternating loop current flows along this loop circuit.

Thus, in the trouble detecting circuit according to Embodiment 3, two loop circuits are formed and the four cold-cathode tube lamps L1, L2, L3, L4 are driven.

Then an equilibrium point (connection point of the load resistor Rp1 and the load resistor Rn1) of the first loop circuit is connected to an equilibrium point (connection point of the load resistor Rp2 and the load resistor Rn2) of the second loop circuit. In Embodiment 3, a monitoring circuit is connected to a connection point connecting these equilibrium points, and monitors a potential of this connection point. The monitoring circuit in Embodiment 3 is the same as that in Embodiment 1, and is formed of an error detection resistor Re and a diode D.

In the following part, an operation of the above circuit will be explained.

In a normal state, potentials at the equilibrium points of the first and second loop circuits are both substantially the same as the potential GND at the ground point and substantially constant. Thus, the potential at the connection point of these equilibrium points is substantially the same as the potential GND at the ground point and substantially constant in a normal state. Therefore, the detection voltage Vs becomes substantially zero.

In an abnormal state, one of the cold-cathode tube lamps L1, L2, L3, L4 turns to an open state or short-circuited state. Accordingly, the current value of the loop current in the first loop circuit or the second loop circuit fluctuates, and a potential v0 at the connection point of the equilibrium points deviates from the potential GND at the ground point and becomes an alternating current having an amplitude. Accompanying this, the detection voltage Vs becomes a voltage value that is not zero according to the trouble. Therefore, for example, when the detection voltage Vs surpasses a predetermined threshold, it is determined that a trouble has occurred.

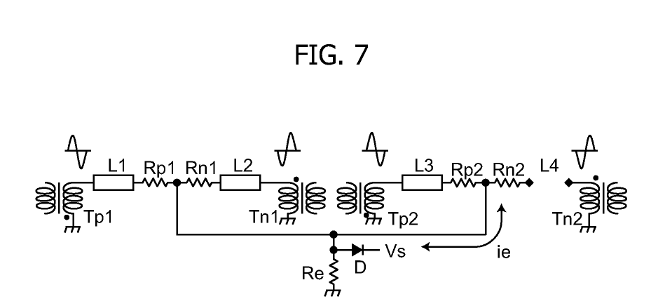

FIG. 7 is a diagram explaining an example of a trouble detection operation in the circuit of FIG. 6B. As shown in FIG. 7, when the cold-cathode tube lamp L4 fails and turns to an open state, the above-described first loop circuit is normal but the above-described second loop circuit is cut, and hence the potential at the equilibrium point of the second loop circuit deviates from the potential GND at the ground point. Accordingly, an error current ie flows through the error detection resistor Re between the equilibrium point of the second loop circuit and the ground point, and a voltage is generated between both ends of the error detection resistor Re. This voltage is rectified and detected as the direct-current detection voltage Vs. Therefore, when a trouble is detected, the detection voltage Vs increases. In addition, also when one of the cold-cathode tube lamps L1, L2, L3 fails and turns to an open state, the detection voltage Vs increases. Further, also when one of the cold-cathode tube lamps L1, L2, L3, L4 fails and turns to a short-circuited state, the detection voltage Vs increases. Further, also when one of the cold-cathode tube lamps L1, L2, L3, L4 fails without reaching an open state or a short-circuited state but consequently the impedance changes slightly, the detection voltage Vs increases.

As mentioned above, the trouble detecting circuit according to Embodiment 3 includes two loop circuits and one monitoring circuit. The monitoring circuit monitors the voltage between a first connection point connecting the two equilibrium points in the two loop circuits and the ground point as a second connection point. Thus, it is possible to detect a trouble of the cold-cathode tube lamps L1, . . . , L4 by detecting a potential variation at the equilibrium points due to fluctuation of the loop current in an abnormal state of the cold-cathode tube lamps L1, . . . , L4. Since one monitoring circuit monitoring a potential at one point is enough for the four cold-cathode tube lamps L1, . . . , L4, the circuit scale of the trouble detecting circuit need not be large when a large number of cold-cathode tube lamps is driven.

### Embodiment 4

A trouble detecting circuit according to Embodiment 4 of the present invention has a plurality k of loop circuits of which each is the same as the loop circuit in Embodiment 1, and monitors a potential at a connection point connecting equilibrium points of all the loop circuits by one monitoring circuit.

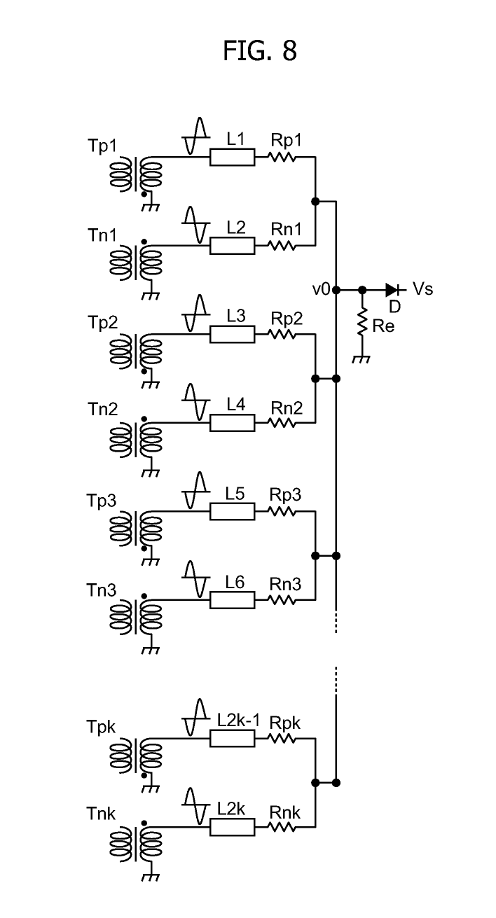

FIG. 8 is a circuit diagram showing a structure of a trouble detecting circuit according to Embodiment 4 of the present invention. As shown in FIG. 8, in Embodiment 4, a plurality k of loop circuits are provided, each of the loop circuits are the same as the loop circuit in Embodiment 1, and a number 2k of cold-cathode tube lamps L1, . . . , L2k are driven. Then, equilibrium points (connection points of a load resistor Rpi and a load resistor Rni) in a normal state of all the loop circuits are connected to each other, and a potential v0 of this connection point is monitored by one monitoring circuit. The monitoring circuit in Embodiment 4 is the same as the monitoring circuit of Embodiment 1.

In the following part, an operation of the above circuit will be explained.

In a normal state, potentials at the equilibrium points of the loop circuits are substantially the same as the potential GND at the ground point and substantially constant. Thus, the potential at the connection point of these equilibrium points is substantially the same as the potential GND at the ground point and substantially constant in a normal state. Therefore, the detection voltage Vs becomes substantially zero.

In an abnormal state, one of the cold-cathode tube lamps L1, . . . , L2k turns to an open state or short-circuited state. Accordingly, the current value of the loop current in one of the loop circuits fluctuates, and a potential v0 at the connection point of the equilibrium points deviates from the potential GND at the ground point and becomes an alternating current having an amplitude. Accompanying this, the detection voltage Vs becomes a voltage value that is not zero according to the trouble. Therefore, for example, when the detection voltage Vs surpasses a predetermined threshold, it is determined that a trouble has occurred.

As mentioned above, the trouble detecting circuit according to Embodiment 4 includes a plurality of loop circuits and one monitoring circuit. The monitoring circuit monitors the voltage between a first connection point connected to a plurality of equilibrium points in the loop circuits and the ground point as a second connection point. Thus, it is possible to detect a trouble of the cold-cathode tube lamps L1, . . . , L2k by detecting a potential variation at the equilibrium points due to fluctuation of the loop current in an abnormal state of the cold-cathode tube lamps L1, . . . , L2k. Since one monitoring circuit monitoring a potential at one point is enough for the number 2k of cold-cathode tube lamps L1, . . . , L2k, the circuit scale of the trouble detecting circuit need not be large when a large number of cold-cathode tube lamps is driven.

### Embodiment 5

The trouble detecting circuit according to Embodiment 5 of the present invention has two loop circuits of which each is the same as the loop circuit in Embodiment 2, and monitors a potential at a connection point connecting equilibrium points of the two loop circuits by one monitoring circuit.

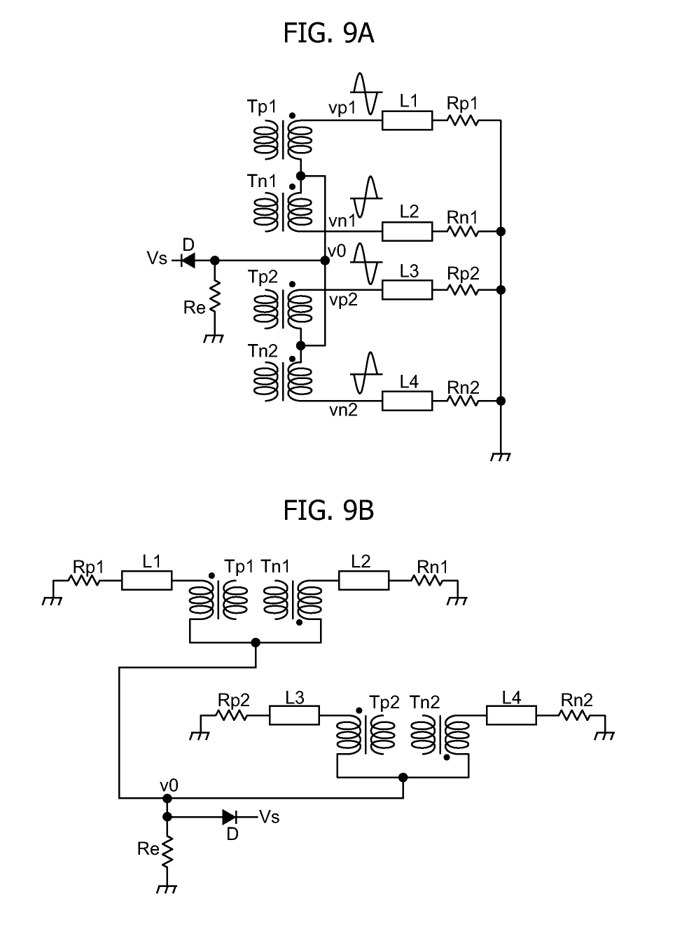

FIG. 9A and FIG. 9B are circuit diagrams showing a structure of the trouble detecting circuit according to Embodiment 5 of the present invention. The circuit in FIG. 9A and the circuit in FIG. 9B are the same.

High-frequency transformers Tp1, Tn1 and load resistors Rp1, Rn1 in Embodiment 5 are the same as the high-frequency transformers Tp, Tn and the load resistors Rp, Rn of Embodiment 2. Therefore, a first loop circuit is formed via cold-cathode tube lamps L1, L2, secondary side windings of the high-frequency transformers Tp1, Tn1 and the load resistors Rp1, Rn1, and in a normal state, an alternating loop current flows along this loop circuit.

Further, high-frequency transformers Tp2, Tn2 and load resistors Rp2, Rn2 in Embodiment 5 are the same as the high-frequency transformers Tp, Tn and the load resistors Rp, Rn of Embodiment 2. Therefore, a second loop circuit is formed via cold-cathode tube lamps L3, L4, secondary side windings of the high-frequency transformers Tp2, Tn2 and the load resistors Rp2, Rn2, and in a normal state, an alternating loop current flows along this loop circuit.

Thus, in the trouble detecting circuit according to Embodiment 5, two loop circuits are formed and the four cold-cathode tube lamps L1, L2, L3, L4 are driven.

Then an equilibrium point (connection point of the secondary side winding of the high-frequency transformer Tp1 and the secondary side winding of the high-frequency transformer Tn1) of the first loop circuit is connected to an equilibrium point (connection point of the secondary side winding of the high-frequency transformer Tp2 and the secondary side winding of the high-frequency transformer Tn2) of the second loop circuit. In Embodiment 5, a monitoring circuit is connected to a connection point connecting these equilibrium points, and monitors a potential of this connection point. The monitoring circuit in Embodiment 5 is the same as that in Embodiment 1.

In the following part, an operation of the above circuit will be explained.

In a normal state, potentials at the equilibrium points of the first and second loop circuits are both substantially the same as the potential GND at the ground point and substantially constant. Thus, the potential at the connection point of these equilibrium points is substantially the same as the potential GND at the ground point and substantially constant in a normal state. Therefore, the detection voltage Vs becomes substantially zero.

In an abnormal state, one of the cold-cathode tube lamps L1, L2, L3, L4 turns to an open state or short-circuited state. Accordingly, the current value of the loop current in the first loop circuit or the second loop circuit fluctuates, and a potential v0 at the connection point of the equilibrium points deviates from the potential GND at the ground point and becomes an alternating current having an amplitude. Accompanying this, the detection voltage Vs becomes a voltage value that is not zero according to the trouble. Therefore, for example, when the detection voltage Vs surpasses a predetermined threshold, it is determined that a trouble has occurred.

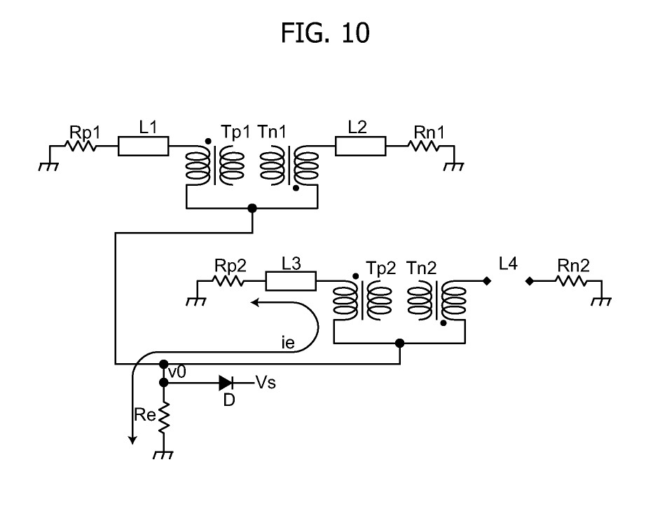

FIG. 10 is a diagram explaining an example of a trouble detection operation in the circuit of FIG. 9B. As shown in FIG. 10, when the cold-cathode tube lamp L4 fails and turns to an open state, the first loop circuit is normal but the second loop circuit is cut, and hence the potential at the equilibrium point of the second loop circuit deviates from the potential GND at the ground point. Accordingly, an error current ie flows through the error detection resistor Re between the equilibrium point of the second loop circuit and the ground point, and a voltage is generated between both ends of the error detection resistor Re. This voltage is rectified and detected as the direct-current detection voltage Vs. Therefore, when a trouble is detected, the detection voltage Vs increases. In addition, also when one of the cold-cathode tube lamps L1, L2, L3 fails and turns to an open state, the detection voltage Vs increases. Further, also when one of the cold-cathode tube lamps L1, L2, L3, L4 fails and turns to a short-circuited state, the detection voltage Vs increases. Further, also when one of the cold-cathode tube lamps L1, L2, L3, L4 fails without reaching an open state or a short-circuited state but consequently the impedance changes slightly, the detection voltage Vs increases.

As mentioned above, the trouble detecting circuit according to Embodiment 5 includes two loop circuits and one monitoring circuit. The monitoring circuit monitors the voltage between a first connection point connecting the two equilibrium points in the two loop circuits and the ground point as a second connection point. Thus, it is possible to detect a trouble of the cold-cathode tube lamps L1, . . . , L4 by detecting a potential variation at the equilibrium points due to fluctuation of the loop current in an abnormal state of the cold-cathode tube lamps L1, . . . , L4. Since one monitoring circuit monitoring a potential at one point is enough for the four cold-cathode tube lamps L1, . . . , L4, the circuit scale of the trouble detecting circuit need not be large when a large number of cold-cathode tube lamps is driven.

### Embodiment 6

A trouble detecting circuit according to Embodiment 6 of the present invention has a plurality of loop circuits of which each is the same as the loop circuit in Embodiment 2, and monitors a potential at a connection point connecting equilibrium points of all the loop circuits by one monitoring circuit.

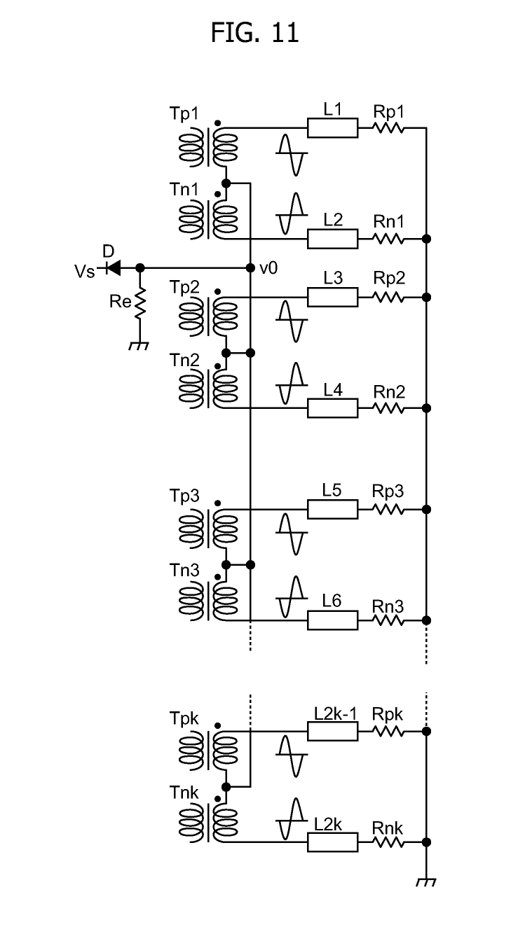

FIG. 11 is a circuit diagram showing a structure of a trouble detecting circuit according to Embodiment 6 of the present invention. As shown in FIG. 11, in Embodiment 6, a plurality k of loop circuits are provided, each of the loop circuits is the same as the loop circuit in Embodiment 2, and a number 2k of cold-cathode tube lamps L1, . . . , L2k are driven. Then, equilibrium points (connection points of a secondary side winding of a high-frequency transformer Tpi and a secondary side winding of a high-frequency transformer Tni) in a normal state of all the loop circuits are connected to each other, and a potential v0 of this connection point is monitored by one monitoring circuit. The monitoring circuit in Embodiment 6 is the same as the monitoring circuit of Embodiment 2.

In the following part, an operation of the above circuit will be explained.

In a normal state, potentials at the equilibrium points of the loop circuits are substantially the same as the potential GND at the ground point and substantially constant. Thus, the potential at the connection point of these equilibrium points is substantially the same as the potential GND at the ground point and substantially constant in a normal state. Therefore, the detection voltage Vs becomes substantially zero.

In an abnormal state, one of the cold-cathode tube lamps L1, . . . , L2k turns to an open state or short-circuited state. Accordingly, the current value of the loop current in one of the loop circuits fluctuates, and a potential v0 at the connection point of the equilibrium points deviates from the potential GND at the ground point and becomes an alternating current having an amplitude. Accompanying this, the detection voltage Vs becomes a voltage value that is not zero according to the trouble. Therefore, for example, when the detection voltage Vs surpasses a predetermined threshold, it is determined that a trouble has occurred.

As mentioned above, the trouble detecting circuit according to Embodiment 6 includes a plurality of loop circuits and one monitoring circuit. The monitoring circuit monitors the voltage between a first connection point connecting a plurality of equilibrium points in the loop circuits and the ground point as a second connection point. Thus, it is possible to detect a trouble of the cold-cathode tube lamps L1, . . . , L2k by detecting a potential variation at the equilibrium points due to fluctuation of the loop current in an abnormal state of the cold-cathode tube lamps L1, . . . , L2k. Since one monitoring circuit monitoring a potential at one point is enough for the number 2k of cold-cathode tube lamps L1, . . . , L2k, the circuit scale of the trouble detecting circuit need not be large when a large number of cold-cathode tube lamps is driven.

### Embodiment 7

A trouble detecting circuit according to Embodiment 7 of the present invention is a circuit for detecting a trouble of two cold-cathode tube lamps driven similarly to Embodiment 1 by one high-frequency transformer provided with an intermediate tap on a secondary side.

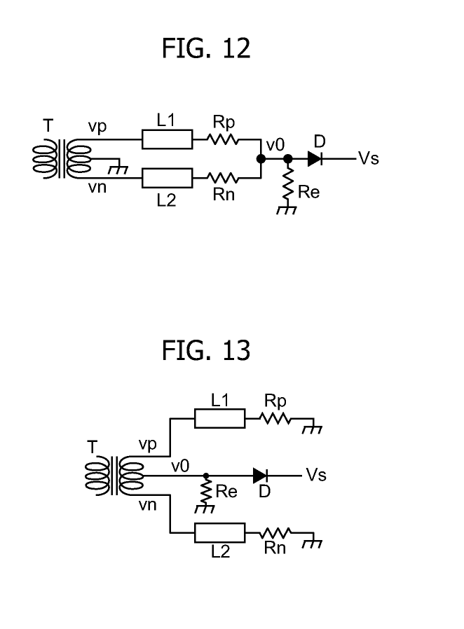

FIG. 12 is a circuit diagram showing a structure of the trouble detecting circuit according to Embodiment 7 of the present invention. The trouble detecting circuit according to Embodiment 7 is a circuit equivalent to the trouble detecting circuit according to Embodiment 1.

In Embodiment 7, instead of the two high-frequency transformers Tp, Tn1, one high-frequency transformer T provided with an intermediate tap on a secondary side winding is provided. The intermediate tap is connected to a ground point. The number of windings between one end of the secondary side winding and the intermediate tap is the same as the number of windings between the other end of the secondary side winding and the intermediate tap. Accordingly, the alternating voltage induced between the one end of the secondary side winding and the intermediate tap has the same amplitude as that of the alternating voltage induced between the other end of the secondary side winding and the intermediate tap. Furthermore, seeing from the ground point, an alternating voltage vp at the one end of the secondary side winding and an alternating voltage vn at the other end of the secondary side winding have phases reverse to each other. In addition, a high-frequency voltage is applied to a primary side winding of the high-frequency transformer T from a primary-side system.

In Embodiment 7, a loop circuit is formed by the secondary side winding of the high-frequency transformer T, load resistors Rp, Rn and cold-cathode tube lamps L1, L2. Then, similarly to Embodiment 1, a connection point of the load resistor Rp and the load resistor Rn becomes an equilibrium point. Accordingly, the potential v0 at the connection point of the load resistor Rp and the load resistor Rn is monitored by a monitoring circuit similarly to Embodiment 1.

Although the trouble detecting circuit according to Embodiment 7 has only one loop circuit, note that a plurality of loop circuits may be provided as in Embodiments 3, 4, and a connection point connecting equilibrium points thereof may be monitored by one monitoring circuit.

### Embodiment 8

A trouble detecting circuit according to Embodiment 8 of the present invention is a circuit for detecting a trouble of two cold-cathode tube lamps driven similarly to Embodiment 2 by one high-frequency transformer provided with an intermediate tap on a secondary side.

FIG. 13 is a circuit diagram showing a structure of the trouble detecting circuit according to Embodiment 8 of the present invention. The trouble detecting circuit according to Embodiment 8 is a circuit equivalent to the trouble detecting circuit according to Embodiment 2. However, to a primary side winding of the high-frequency transformer T, a high-frequency voltage of one system is applied.

In Embodiment 8, instead of the two high-frequency transformers Tp, Tn1, one high-frequency transformer T provided with an intermediate tap on a secondary side winding is provided. The number of windings between one end of the secondary side winding and the intermediate tap is the same as the number of windings between the other end of the secondary side winding and the intermediate tap, and the alternating voltage induced between the one end of the secondary side winding and the intermediate tap has the same amplitude as that of the alternating voltage induced between the other end of the secondary side winding and the intermediate tap. Furthermore, seeing from the intermediate tap, an alternating voltage vp at the one end of the secondary side winding and an alternating voltage vn at the other end of the secondary side winding have phases reverse to each other.

In Embodiment 8, a loop circuit is formed by the secondary side winding of the high-frequency transformer T, load resistors Rp, Rn, and cold-cathode tube lamps L1, L2. Then, the intermediate tap of the high-frequency transformer T becomes an equilibrium point. Accordingly, the potential v0 at the intermediate tap of the high-frequency transformer T is monitored by a monitoring circuit similarly to Embodiment 2.

Although the trouble detecting circuit according to Embodiment 8 has only one loop circuit, note that a plurality of loop circuits may be provided as in Embodiments 5, 6, and a connection point connecting equilibrium points thereof may be monitored by one monitoring circuit.

### Embodiment 9

A trouble detecting circuit according to Embodiment 9 of the present invention has a circuit for monitoring an output voltage of the secondary side windings of the high-frequency transformers Tp, Tn in the circuit of Embodiment 1.

In Embodiment 1, even if both the cold-cathode tube lamps L1, L2 fail at different timings, the trouble can be detected by monitoring the detection voltage Vs along a time series. In Embodiment 9, even if the two cold-cathode tube lamps L1, L2 fail simultaneously, it is possible to detect the trouble.

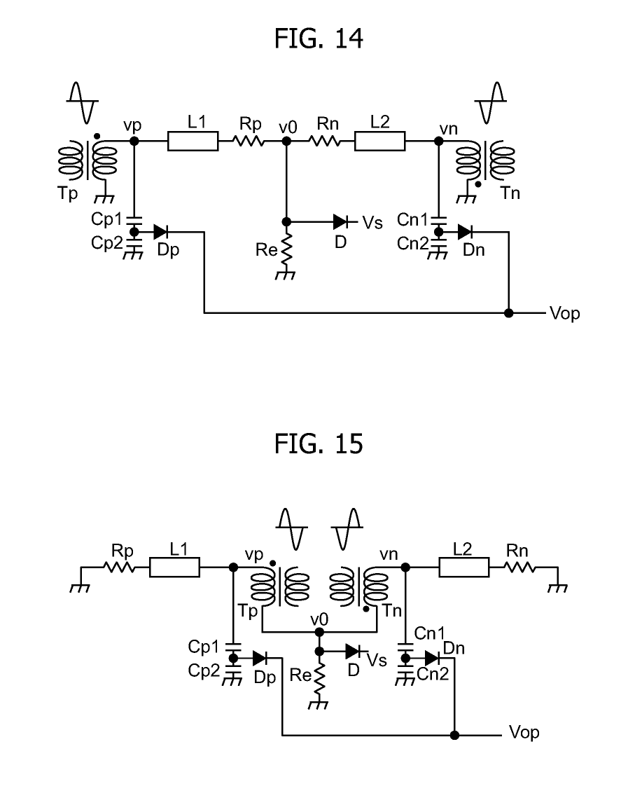

FIG. 14 is a circuit diagram showing a structure of the trouble detecting circuit according to Embodiment 9 of the present invention. In the circuit shown in FIG. 14, a series circuit of capacitors Cp1, Cp2 is connected in parallel to the secondary side winding of the high-frequency transformer Tp. Then a diode Dp is connected to a connection point of the capacitor Cp1 and the capacitor Cp2. Accordingly, an inter-terminal voltage vp of the secondary side winding of the high-frequency transformer Tp is divided by the capacitors Cp1, Cp2, and the alternating voltages after the division are rectified by the diode Dp.

Further, in the circuit shown in FIG. 14, a series circuit of capacitors Cn1, Cn2 is connected in parallel to the secondary side winding of the high-frequency transformer Tn. Then a diode Dn is connected to a connection point of the capacitor Cn1 and the capacitor Cn2. Accordingly, an inter-terminal voltage vn of the secondary side winding of the high-frequency transformer Tn is divided by the capacitors Cn1, Cn2, and the alternating voltages after the division are rectified by the diode Dn. Note that the capacitors Cn1, Cn2 and the diode Dn are the same as the capacitors Cp1, Cp2 and the diode Dp.

Furthermore, a cathode of the diode Dp and a cathode of the diode Dn are connected, and whether a trouble occurs or not is determined based on a direct-current detection voltage Vop at a connection point of the cathodes.

Note that the other structure of the circuit shown in FIG. 14 is the same as in FIG. 1, and thus explanation thereof is omitted.

In the following part, an operation of the above circuit will be explained.

In the circuit shown in FIG. 14, when one of the cold-cathode tube lamps L1, L2 fails, the trouble is detected similarly to Embodiment 1.

Furthermore, in the circuit shown in FIG. 14, when both the cold-cathode tube lamps L1, L2 fail and become open, the loads on the secondary sides of the high-frequency transformers Tp, Tn disappear, and hence the voltages vp, vn of the secondary side windings of the high-frequency transformers Tp, Tn increase. Accompanying this, also the detection voltage Vop increases. Therefore, for example, when the detection voltage Vop surpasses a predetermined threshold, it is determined that a trouble has occurred.

Note that in Embodiment 9, the circuit monitoring the secondary side output voltage of the high-frequency transformers is added to the circuit of Embodiment 1, but a similar circuit may be added to the circuit of Embodiment 3 or 4.

As mentioned above, according to Embodiment 9, a circuit is provided for monitoring the amplitudes of the secondary side output voltages of the high-frequency transformers Tp, Tn. Accordingly, even if both the cold-cathode tube lamps L1, L2 fail, the trouble can be detected.

### Embodiment 10

A trouble detecting circuit according to Embodiment 10 of the present invention has a circuit for monitoring an output voltage on the secondary side windings of the high-frequency transformers Tp, Tn in the circuit of Embodiment 2.

In Embodiment 2, even if both the cold-cathode tube lamps L1, L2 fail at different timings, the trouble can be detected by monitoring the detection voltage Vs along a time series. In Embodiment 10, even if the two cold-cathode tube lamps L1, L2 fail simultaneously, it is possible to detect the trouble.

FIG. 15 is a circuit diagram showing a structure of the trouble detecting circuit according to Embodiment 10 of the present invention. In the circuit shown in FIG. 15, a circuit similar to the circuit shown in FIG. 14 is provided for monitoring the voltages vp, vn of the secondary side windings of the high-frequency transformers Tp, Tn.

Note that the other structure of the circuit shown in FIG. 15 is the same as in FIG. 4, and thus explanation thereof is omitted.

In the following part, an operation of the above circuit will be explained.

In the circuit shown in FIG. 15, when one of the cold-cathode tube lamps L1, L2 fails, the trouble is detected similarly to Embodiment 2.

Furthermore, in the circuit shown in FIG. 15, when both the cold-cathode tube lamps L1, L2 fail and become open, the loads on the secondary sides of the high-frequency transformers Tp, Tn disappear, and hence the voltages vp, vn of the secondary side windings of the high-frequency transformers Tp, Tn increase. Accompanying this, also the detection voltage Vop increases. Therefore, for example, when the detection voltage Vop surpasses a predetermined threshold, it is determined that a trouble has occurred.

Note that in Embodiment 10, the circuit monitoring the secondary side output voltage of the high-frequency transformers is added to the circuit of Embodiment 2, but a similar circuit may be added to the circuit of Embodiment 5 or 6.

As mentioned above, according to Embodiment 10, a circuit is provided for monitoring the amplitudes of the secondary side output voltages of the high-frequency transformers Tp, Tn. Accordingly, even if both the cold-cathode tube lamps L1, L2 fail, the trouble can be detected.

It should be noted that, although the above-described embodiments are preferable examples of the present invention, the present invention is not limited to them. Various modifications and changes are possible within the range not departing from the spirit of the present invention.

For example, a plurality of cold-cathode tube lamps are driven in the above-described embodiments, but it may be structured to drive other types of discharge tube lamps instead of the cold-cathode tube lamps.

Furthermore, in the above-described embodiment, only the error detection resistor Re and the diode D are exemplified as the monitoring circuit, but a smoothing circuit such as a capacitor may be provided for smoothing an output voltage of the diode D. Further, a determination circuit may be provided for detecting the output voltage of the diode D to determine whether or not an aforementioned trouble has occurred.

The present invention is applicable to a trouble detecting circuit in, for example, an inverter circuit for a backlight of multiple light type with cold-cathode tube lamps.

Having described the present invention including various features and variations thereof, it is intended that the appended claims be interpreted as including the embodiments described herein, the alternatives mentioned above, and all equivalents thereto.

What is claimed is:

1. A trouble detecting circuit, comprising:
a loop circuit conducting a loop current to two discharge tube lamps in a normal state, the two discharge tube lamps driven with two alternating driving voltages having phases reverse to each other by one or two secondary side windings of one or two transformers; and
a monitoring circuit monitoring a voltage between two points which are at a substantially same potential in a normal state in the loop circuit.

2. The trouble detecting circuit according to claim 1, wherein one of the two points is a ground point.

3. The trouble detecting circuit according to claim 2, wherein the other one of the two points is grounded via a detection resistor.

4. The trouble detecting circuit according to claim 2, wherein the monitoring circuit is connected to a lower voltage side of the two discharge tube lamps.

5. The trouble detecting circuit according to claim 2, wherein the monitoring circuit is connected to a lower voltage side of the secondary side windings of the two transformers.

6. A trouble detecting circuit, comprising:
a plurality of loop circuits of which each conducts a loop current to two discharge tube lamps in a normal state, the two discharge tube lamps driven with two alternating driving voltages having phases reverse to each other by one or two secondary side windings of one or two transformers; and
a monitoring circuit monitoring a voltage between a first connection point and a second connection point, the first connection point connected to a plurality of first points, the second connection point connected to a plurality of second points, a respective one of the first points and a respective one of the second points being at substantial same potential in a respective one of the loop circuits in a normal state.
